(19) United States
(12) Patent Application Publication
(10) Pub. No.: US 2025/0245474 A1
(43) Pub. Date: Jul. 31, 2025

(54) SYSTEM AND METHOD FOR GENERATING DYNAMIC VISUAL ARTIFACTS THAT SIMULATE EMOTIONAL EXPERIENCES

(71) Applicant: Toyota Research Institute, Inc., Los Altos, CA (US)

(72) Inventors: Evelyne N. Kimani, Los Altos, CA (US); Hye Jin Yeom, Los Altos, CA (US)

(73) Assignees: Toyota Research Institute, Inc., Los Altos, CA (US); Toyota Jidosha Kabushiki Kaisha, Toyota-shi (JP)

(21) Appl. No.: 18/821,198

(22) Filed: Aug. 30, 2024

Related U.S. Application Data
(60) Provisional application No. 63/624,889, filed on Jan. 25, 2024.

(51) Int. Cl. G06N 3/006; G06N 3/0455; G06N 3/0475

(52) U.S. Cl. CPC G06N 3/006; G06N 3/0455; G06N 3/0475

(57) ABSTRACT

A method and system configured to generate emotionally resonant visual content may include receiving multimodal data comprising at least one design element and emotion input data associated with one or more target emotional states; determining emotion encoding parameters corresponding to the one or more target emotional states; generating synthetic visual content reflecting the at least one design element and the one or more target emotional states; and displaying, in a user interface, the synthetic visual content reflecting the target emotional states, the user interface configured to receive one or more controls to modify at least one of the emotion input data or the target emotional states to modify the displayed synthetic visual content.

### CROSS-REFERENCE TO RELATED APPLICATIONS

This Application claims the benefit of and priority to U.S. Provisional Patent Application No. 63/624,889, filed on Jan. 25, 2024, the entire contents of which are hereby incorporated by reference.

### TECHNICAL FIELD

The present specification generally relates to systems and methods for generating designs using machine learning techniques and generative models.

### BACKGROUND

In the field of design, the ability to create visually appealing and emotionally resonant designs is important. Designers across various domains, such as product design, graphic design, and user experience design, strive to create designs that not only meet functional requirements but also evoke desired emotional responses from users. Effective design has the power to engage users, create memorable experiences, and establish strong connections between users and products or brands.

Traditionally, the design process has relied heavily on the skills, experience, and creativity of individual designers. Designers often draw inspiration from various sources, such as nature, art, or existing designs, and use their expertise to create visually compelling compositions. However, the process of manually creating designs that effectively convey specific emotions can be time-consuming, iterative, and subjective. Designers may need to go through multiple rounds of ideation, sketching, and refinement to arrive at a design that aligns with their intended emotional impact.

Moreover, the field of design has seen a significant shift towards digitalization and the use of computer-aided design (CAD) tools. These tools have greatly enhanced the efficiency and precision of the design process, allowing designers to create, modify, and visualize designs more quickly and accurately. However, despite the advancements in digital design tools, the process of incorporating emotional attributes into designs still heavily relies on the designer's intuition and expertise.

The emotional impact of a design is a complex and multifaceted aspect that involves understanding human perception, psychology, and cultural factors. Designers often rely on their intuition, experience, and knowledge of color theory, composition, and other design principles to create emotionally evocative designs. However, there is a lack of systematic and data-driven approaches to capturing and integrating emotional attributes into the design process. Designers would greatly benefit from tools and systems that can assist them in creating designs that effectively convey desired emotions, while still allowing for creative exploration and refinement.

### SUMMARY

In one embodiment, an apparatus configured to generate emotionally resonant visual content includes: receiving information corresponding to multimodal data comprising at least one design element and emotion input data associated with one or more target emotional states; determining emotion encoding parameters corresponding to the one or more target emotional states; generating synthetic visual content reflecting the at least one design element and the one or more target emotional states; and displaying, in a user interface, the synthetic visual content reflecting the target emotional states, the user interface configured to receive one or more controls to modify at least one of the emotion input data or the target emotional states to modify the displayed synthetic visual content.

In another embodiment, a method for generating emotionally resonant visual content includes: receiving multimodal data comprising at least one design element and emotion input data associated with one or more target emotional states; determining emotion encoding parameters corresponding to the one or more target emotional states; generating, using a machine learning model trained on training data encoding correlations between emotion encoding parameters and visual properties, synthetic visual content reflecting the at least one design element and the one or more target emotional states; and displaying, in a user interface, the synthetic visual content reflecting the target emotional states, the user interface configured to receive one or more controls to modify at least one of the emotion input data or the target emotional states to modify the displayed synthetic visual content.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 generally depicts an emotion-based design generation system according to one or more embodiments shown and described herein;

FIG. 2 generally depicts a user input interface of the emotion-based design generation system according to one or more embodiments shown and described herein;

FIG. 3 generally depicts a training process for an emotion-visual generative model used in the emotion-based design generation system according to one or more embodiments shown and described herein;

FIG. 4 generally depicts a user output interface of the emotion-based design generation system according to one or more embodiments shown and described herein;

FIG. 5 generally depicts an example application of the emotion-based design generation system in the context of product design according to one or more embodiments shown and described herein;

FIG. 6 generally depicts a flowchart illustrating a process of using the emotion-based design generation system according to one or more embodiments shown and described herein;

FIG. 7 generally depicts a training data pipeline for the emotion-visual generative model used in the emotion-based design generation system according to one or more embodiments shown and described herein;

FIG. 8 generally depicts components and data flow within an emotion-visual generative model architecture according to one or more embodiments shown and described herein; and

FIG. 9 generally depicts an example processing system configured to implement the emotion-based design generation system according to one or more embodiments shown and described herein.

### DETAILED DESCRIPTION

Aspects of the present disclosure provide apparatuses, methods, processing systems, and computer-readable mediums for generating emotionally resonant designs using machine learning techniques and generative models.

The present disclosure describes an emotion-based design generation system that enables designers to create visually appealing and emotionally expressive designs in an automated and data-driven manner. The system leverages a trained emotion-visual generative model that learns the relationships between visual elements and emotional attributes from a diverse dataset of multimedia content. Users can input design elements, emotions, and intensities through an intuitive user interface, and a generative model generates designs that effectively convey the desired emotions. The generated designs can be further refined and customized through interactive controls and exported for various applications.

Designing visually appealing and emotionally resonant artifacts can be a challenging task that heavily relies on the designer's intuition, experience, and creativity. Existing design tools lack systematic and data-driven approaches to capturing and integrating emotional attributes into the design process. Designers often struggle to create designs that effectively evoke specific emotions and resonate with users on a deep, emotional level. The manual and iterative nature of the design process can be time-consuming and subjective, leading to inconsistent and suboptimal results.

In some aspects, the emotion-based design generation system addresses these challenges by providing a technical solution that leverages machine learning and generative models. The system includes an emotion-visual generative model trained on a diverse dataset of emotionally annotated multimedia content. The model learns the intricate relationships between visual elements and emotional attributes, enabling it to generate designs that effectively convey desired emotions. The system also includes user input and output interfaces that allow designers to specify their design preferences, emotions, and intensities, and interact with the generated designs. The generated designs can be refined and customized through interactive controls, providing flexibility and creative control to the designers.

In some aspects, the emotion-based design generation system offers several benefits and advantages over existing design tools and workflows. By automating the process of generating emotionally resonant designs, the system saves designers time and effort, allowing them to focus on higher-level creative tasks. The data-driven approach ensures that the generated designs are grounded in real-world emotional associations and are more likely to resonate with users. The interactive nature of the system enables designers to explore and refine designs iteratively, facilitating rapid prototyping and experimentation. The ability to customize and export the generated designs makes the system versatile and applicable to a wide range of design domains and applications. Thus, such the emotion-based design generation system empowers designers to create emotionally engaging and impactful designs more efficiently and effectively, ultimately enhancing user experiences and engagement.

In some aspects, the emotion-based design generation system described herein provides a technical solution to the problem of creating emotionally resonant designs in a manual, time-consuming, and subjective manner. By leveraging machine learning techniques and generative models, the system enables designers to automatically generate designs that effectively convey desired emotions based on user inputs and preferences. This improves upon existing design tools that rely heavily on the designer's intuition and expertise, lacking systematic and data-driven approaches to capturing and integrating emotional attributes into the design process. The techniques advance the field of design by enabling the creation of emotionally engaging designs tailored to specific user requirements and contexts.

The integration of the emotion-visual generative model with user input interfaces and output interfaces, as described herein, adds additional functionality to conventional design workflows. The ability to input design elements, emotions, and intensities through a user-friendly interface provides a flexible and intuitive means for designers to express their creative intent. A generative model, trained on a diverse dataset of emotionally annotated multimedia content, learns the intricate relationships between visual elements and emotional attributes, enabling the generation of designs that effectively evoke the desired emotions. This provides a technical improvement over existing design tools that lack the capability to capture and incorporate emotional aspects in a data-driven and automated manner.

A training data pipeline and architecture of the emotion-visual generative model described herein leverage machine learning techniques to solve the technical problem of generating emotionally expressive designs. The collection, preprocessing, and augmentation of a diverse dataset of multimedia content with emotional annotations enable the model to learn the complex mappings between visual elements and emotional attributes. An encoder-decoder architecture, combined with adversarial training, allows the model to generate designs that are not only visually appealing but also emotionally coherent and realistic. The technical solution equips designers with a powerful tool to explore and create designs that resonate with users on a deep, emotional level, enhancing user engagement and experiences.

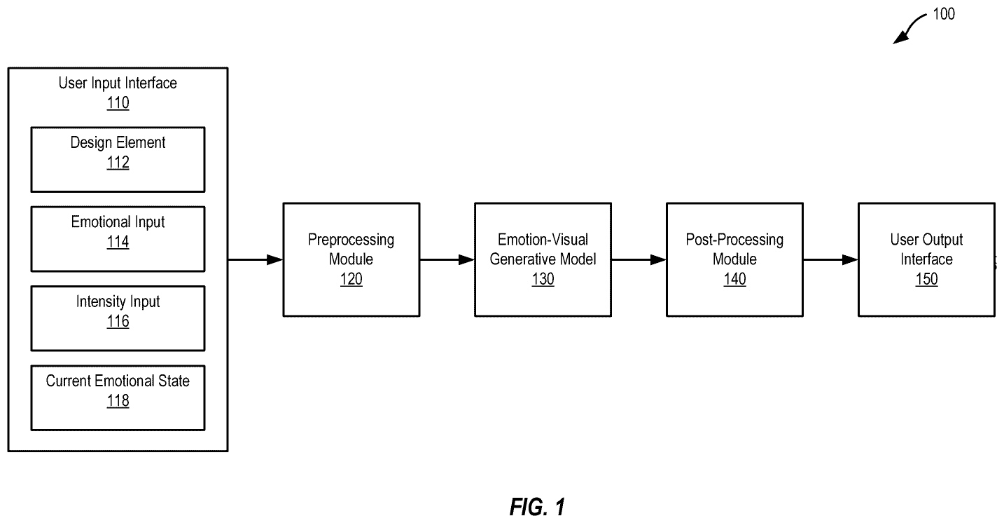

In accordance with aspects of the present disclosure, FIG. 1 illustrates an emotion-based design generation system 100. In certain aspects, the emotion-based design generation system 100 provides an approach to creating designs that effectively convey desired emotions by leveraging machine learning and generative models. The emotion-based design generation system 100 can allow users to input their design preferences and emotional intentions, and generate corresponding designs that embody those emotions. Further, the emotion-based design generation system 100 can find applications in various domains, such as product design, marketing, user experience design, and artistic creation. The emotion-based design generation system 100 can empower designers and creators to explore and express emotions through visual and multimedia elements, enhancing the emotional impact and engagement of their designs.

The emotion-based design generation system 100 includes several components that work together to achieve an objective. These components include a user input interface 110, a preprocessing module 120, an emotion-visual generative model 130, a post-processing module 140, and a user output interface 150. In certain aspects, the user input interface 110 serves as a primary point of interaction between the user and the emotion-based design generation system 100. The user input interface 110 provides a user-friendly and intuitive means for users to specify their design preferences and emotional intentions, which serve as inputs to guide a design generation process. The user input interface 110 offers a range of input options to capture various aspects of the user's requirements and preferences. One of the inputs provided through the user input interface 110 is the design element 112. In certain aspects, the design element 112 represents the main object or inspiration for the generated design. The design element 112 can be a specific item, such as a leaf, teapot, car, or any other object that the user wishes to use as the basis for their design. The user input interface 110 allows users to enter or select the desired design element 112, providing flexibility and customization options to suit their creative vision.

Another input captured by the user input interface 110 is the emotional input 114. The emotional input 114 represents the desired emotion or emotions that a user wants to convey through the generated design. In some examples, users can enter in one or more emotions, such as excitement, calmness, happiness, or any other relevant emotion. Alternatively, or in addition, users can select one or more emotions from a range of predefined emotions, such as excitement, calmness, happiness, or any other relevant emotion. The user input interface 110 provides an intuitive way for users to express their emotional intentions, enabling the emotion-based design generation system 100 to generate designs that effectively evoke the desired emotional response.

In addition to the design element 112 and emotional input 114, the user input interface 110 can include an intensity input 116. In certain aspects, the intensity input 116 allows users to adjust the strength or prominence of the selected one or more emotions in the generated design. Users can fine-tune the emotional intensity using sliders, input fields, or other interactive controls provided by the user input interface 110. This feature enables users to modulate the emotional expression in the generated design, allowing for greater control and customization.

In some aspects of the present disclosure, the user input interface 110 may include additional features to enhance the user experience and provide more personalized design generation. For example, the user input interface 110 may incorporate sensors or input devices to capture the user's current emotional state 118. This can involve various modalities, such as facial expression recognition, voice analysis, or physiological sensors that measure arousal levels. By considering the user's current emotional state 118, the emotion-based design generation system 100 can generate designs that resonate with the user's mood or emotional context, creating a more immersive and engaging experience for the user.

In accordance with examples of the present disclosure, the preprocessing module 120 can receive the user inputs from the user input interface 110 and perform data transformations and formatting. The preprocessing module 120 can help to ensure that the user inputs are properly processed and prepared for utilization by the subsequent components of the emotion-based design generation system 100. In some aspects, one of the tasks of the preprocessing module 120 is to handle the design element 112. The preprocessing module 120 may apply feature extraction or encoding techniques to represent the design element 112 in a format suitable for the emotion-visual generative model 130. This may involve converting the design element 112 into a numerical or categorical representation that can be effectively processed by the generative model. Similarly, the preprocessing module 120 can process the emotional input 114 and intensity input 116 provided by the user. The preprocessing module 120 can transform these inputs into emotion encoding parameters, which may be numerical or categorical representations that capture characteristics and attributes of the desired emotions. The preprocessing module 120 may employ various techniques, such as encoding schemes or mapping functions, to convert the emotional inputs into a format that aligns with the training data and architecture of the generative model. For example, if a user inputs “leaf” as the design element and selects “excitement” as the desired emotion with a high intensity, the preprocessing module 120 may convert “leaf” into a numerical vector representation and encode “excitement” and its intensity into corresponding emotion parameters that the generative model can interpret and incorporate into the design generation process.

Similarly, the preprocessing module 120 can process the emotional input 114 and intensity input 116 provided by the user. The preprocessing module 120 can transform these inputs into a numerical or categorical representation that can be understood and utilized by the emotion-visual generative model 130. The preprocessing module 120 may employ various techniques, such as encoding schemes or mapping functions, to convert the emotional inputs into a format that aligns with the training data and architecture of the generative model. In cases where the user's current emotional state 118 is captured by the user input interface 110, the preprocessing module 120 can handle the integration of this information with the other inputs. The preprocessing module 120 may apply emotion recognition algorithms or data fusion techniques to combine the user's current emotional state 118 with the design element 112, emotional input 114, and/or intensity input 116. This integration allows the emotion-based design generation system 100 to consider the user's emotional context in the design generation process.

The preprocessing module 120 helps to ensure that the user inputs are transformed into a consistent and compatible format for effective utilization by the emotion-visual generative model 130. In aspects, the preprocessing module 120 acts as a bridge between the user input interface 110 and the emotion-visual generative model 130, facilitating the flow of information and enabling the generation of emotionally resonant designs.

In certain aspects, the emotion-visual generative model 130 may be a pre-trained machine learning model that is at the core of the emotion-based design generation system 100. The emotion-visual generative model 130 can take the preprocessed user inputs from the preprocessing module 120 and generate a synthetic design based on the specified design element and emotional attributes. In certain aspects, the emotion-visual generative model 130 has undergone a training process using a large dataset of images, videos, and other multimedia data, along with associated emotional labels and annotations. During the training phase, the emotion-visual generative model 130 learns the correlations and patterns between visual elements and emotional expressions. Thus, the emotion-visual generative model 130 can develop the ability to map emotional inputs to corresponding visual features and styles, enabling the generation of designs that effectively convey the desired emotions.

In some aspects, the emotion-visual generative model 130 employs one or more machine learning techniques, such as deep learning architectures and generative adversarial networks (GANs), to synthesize novel designs. The emotion-visual generative model 130 encodes the emotional inputs into a latent space representation, capturing characteristics and attributes of the desired emotions. The latent space representation serves as a compact and abstract representation of the emotional intent, allowing the emotion-visual generative model 130 to generate designs that embody the specified emotions. By leveraging the learned mappings between visual elements and emotional attributes, the emotion-visual generative model 130 combines the encoded emotional attributes with the visual elements of the specified design object. In certain aspects, the emotion-visual generative model 130 can synthesize a unique design that effectively conveys the desired emotional expression while maintaining the essence of the design element. The emotion-visual generative model 130 can generate designs in various formats, such as static images, animations, or interactive visualizations, depending on the desired output modality and the requirements of the specific application.

In some examples, the post-processing module 140 receives the generated design from the emotion-visual generative model 130 and performs refinements and adaptations, if any. The post-processing module 140 can enhance the visual quality and coherence of the generated design, ensuring that the design meets the user's expectations and preferences. In some aspects, the post-processing module 140 may apply one or more image enhancement techniques to improve the overall appearance of the generated design. This may involve techniques such as smoothing, sharpening, or adjusting contrast and brightness levels. By applying these enhancements, the post-processing module 140 aims to create visually appealing and polished designs that effectively convey the desired emotions.

In addition to image enhancement, the post-processing module 140 may also incorporate additional constraints or preferences specified by the user. For example, the user may have specific color schemes, composition rules, or branding guidelines that need to be adhered to. The post-processing module 140 can take these constraints into account and adapts the generated design accordingly. Another aspect of the post-processing module 140 is its ability to generate multiple variations of the design. By applying different styles, perspectives, or emotional intensities, the post-processing module 140 can create a range of design options that offer different visual interpretations while still conveying the intended emotions.

In examples, the user output interface 150 is the final component of the emotion-based design generation system 100, responsible for presenting the generated designs to the user for viewing, interaction, and feedback. The user output interface 150 serves as the primary point of interaction between the user and the generated designs, providing an intuitive and engaging experience. In some examples, the user output interface 150 displays the synthesized designs in a visually appealing and immersive manner, allowing users to fully appreciate the emotional qualities and aesthetic details of the designs. It may employ various visualization techniques, such as high-resolution graphics, interactive elements, or multimedia presentations, to effectively showcase the generated designs and their emotional attributes.

In examples, users can engage with the generated designs through various controls and options provided by the interface. For example, users may have the ability to adjust the emotional intensity of the designs in real-time, triggering the system to regenerate the designs with updated intensity levels. This interactive feature allows users to fine-tune the emotional expression and explore different variations of the designs based on their preferences. In addition to interactivity, the user output interface 150 can facilitate user feedback and collaboration. That is, users can provide their opinions, suggestions, and ratings for the generated designs directly through the interface. This feedback mechanism allows users to communicate their satisfaction or suggest further refinements to the designs. The user output interface 150 may also include sharing and collaboration features, allowing users to easily share the generated designs with others, gather feedback from collaborators, or integrate the designs into their creative workflows.

The user output interface 150 may offer additional functionalities to enhance the user experience and facilitate the utilization of the generated designs. The user output interface 150 may provide options to save, export, or download the designs in various file formats, enabling users to incorporate the designs into their projects or further refine them using external tools. The user output interface 150 may also include tutorials, guides, or helpful resources to assist users in effectively leveraging the emotion-based design generation system 100 and maximizing the potential of the generated designs.

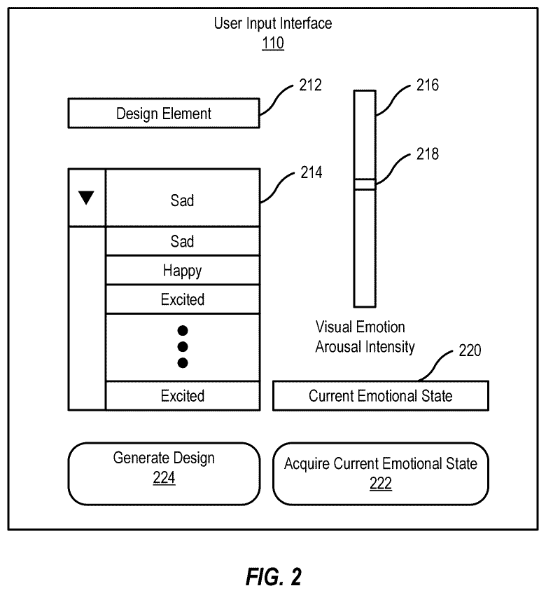

FIG. 2 illustrates an example of the user input interface 110 of the emotion-based design generation system 100, in accordance with aspects of the present disclosure. As previously mentioned, the user input interface 110 provides a user-friendly and intuitive means for users to specify their design preferences and emotional intentions, which serve as inputs to guide the design generation process. The user input interface 110 can provide a range of input options and interactive elements that allow users to express their creative vision and desired emotional attributes effectively.

In some aspects, the user input interface 110 includes several key components that facilitate the capturing of user inputs. These components can include the design element 212, the emotion input section 214, the visual emotion arousal level element 216, the visual emotion arousal level slider 218, the current emotional state 220, the acquire current emotional state button 222, and the generate design button 224. Each component works to enable users to provide the necessary information for generating emotionally resonant designs. For example, the design element 212 can allow users to specify the main object or inspiration for the generated design. The design element 212 can be a text input field, a dropdown menu, or a visual selection interface that enables users to enter or select the desired design element. For example, if a user wants to create a design inspired by nature, the user may select “leaf” from a dropdown menu or click on an icon representing a leaf.

In some aspects of the present disclosure, the design element 212 may offer a wide range of predefined options covering various categories, such as natural objects, man-made objects, abstract shapes, or specific product types. Users can browse through these options and select the one that aligns with their design intent. Additionally, the design element 212 may allow users to provide custom input by typing in a specific object or concept that is not listed in the predefined options, providing flexibility and creative freedom to users.

In some aspects, the emotion input section 214 is another component of the user input interface 110, enabling users to specify one or more desired emotion or one or more emotions they want to convey through the generated design. The emotion input section 214 can be implemented as a dropdown menu, radio buttons, or emotion icons that users can click on to select their preferred emotion(s). In some examples, the emotion input section 214 may include a comprehensive list of emotions, such as excitement, calmness, happiness, sadness, anger, or any other relevant emotion. Each emotion option may have a corresponding visual representation, such as an emoji or an expressive illustration, to help users easily identify and select the desired emotion. For instance, if a user wants to create a design that evokes a sense of tranquility, they can select the “calmness” option from the dropdown menu or click on an icon depicting a serene landscape.

In certain aspects, the visual emotion arousal level element 216 is an interactive component of the user input interface 110 that allows users to adjust the intensity or strength of the selected emotion(s). The visual emotion arousal level element 216 can be represented as a slider or a set of input fields that enable users to fine-tune the emotional intensity to their desired level. The visual emotion arousal level slider 218 is a specific implementation of the visual emotion arousal level element 216. The visual emotion arousal level slider 218 provides an intuitive and user-friendly way for users to adjust the emotional intensity by dragging a slider handle or clicking on a specific point along the slider. The bottom end of the slider may represent a low intensity, while the top end may represent a high intensity. Users can move the slider to the desired position to indicate the strength of the emotions they want to convey in the generated design.

In some aspects of the present disclosure, the visual emotion arousal level element 216 may include additional features, such as numeric input fields or predefined intensity levels (e.g., low, medium, high), to provide more precise control over the emotional intensity. The visual emotion arousal level element 216 may also include visual cues or tooltips to guide users in understanding the impact of different intensity levels on the generated designs.

The current emotional state 220 can be an optional component of the user input interface 110 that allows users to provide information about their current emotional state. The current emotional state 220 can be useful in scenarios where users want to create designs that resonate with their current mood or emotional context. The acquire current emotional state button 222 can be an interactive element associated with the current emotional state 220. When clicked or tapped, the acquire current emotional state button 222 can initiate a process of capturing the user's current emotional state using various input modalities. For example, the acquire current emotional state button 222 may trigger the activation of sensors or input devices, such as facial expression recognition cameras, voice analysis microphones, or physiological sensors, to gather data about the user's emotional cues. In some examples, the acquire current emotional state button 222 may also provide users with alternative methods to input their current emotional state, such as selecting from a list of predefined options or using self-report scales. These options allow users to manually indicate their emotional state if they prefer not to use automated emotion detection methods.

The generate design button 224 serves as a trigger for initiating the design generation process based on the user's provided inputs. When users have specified one or more desired design element, emotions, intensity, and optionally their current emotional state, they can click or tap on the generate design button 224 to start the generation process. Upon clicking the generate design button 224, the user inputs can be processed by the preprocessing module 120 and fed into the emotion-visual generative model 130 to generate the corresponding design. The generate design button 224 may provide visual feedback, such as changing color or displaying a loading indicator, to inform users that the generation process is underway.

In some aspects of the present disclosure, the generate design button 224 may include additional options or settings, such as the ability to specify a desired output format (e.g., static image, animation, interactive visualization) or a number of design variations to generate. These options can provide users with more control over the generation process and allow them to tailor the output to their specific needs. The user input interface 110, as illustrated in FIG. 2, serves as the gateway for users to harness the power of the emotion-based design generation system 100 and create designs that resonate with their intended emotional expression.

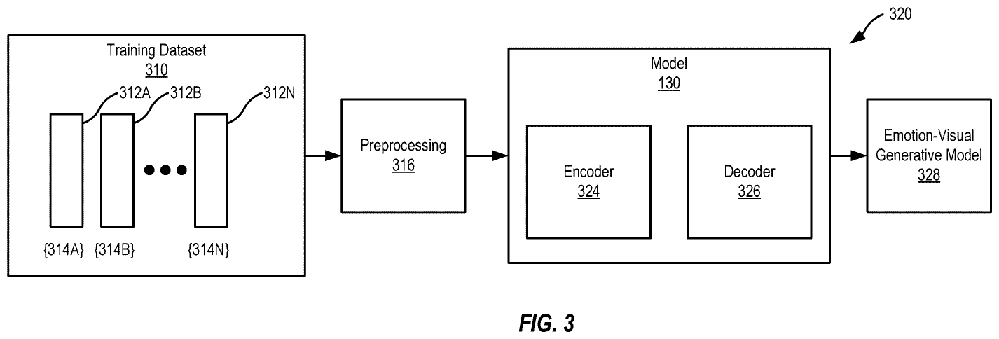

In accordance with aspects of the present disclosure, FIG. 3 illustrates the training process of the emotion-visual generative model 130, which can be a key component of the emotion-based design generation system 100. The emotion-visual generative model 130 can learn to synthesize designs that effectively convey desired emotions by leveraging a large dataset of multimedia content and associated emotional annotations. The training process depicted in FIG. 3 begins with the training dataset 310. The training dataset 310 can include a diverse collection of one or more images, videos, and other multimedia data that serve as the foundation for training the emotion-visual generative model 130. The training dataset 310 can include a wide range of visual content, such as photographs, illustrations, graphic designs, and video clips, covering various domains and styles.

Each data sample 312A-312N in the training dataset 310 can be labeled with one or more emotional annotations 314A-314N that describe the emotional attributes associated with the visual content of the corresponding data sample 312A-312N. The emotional annotations 314A-314N can be in the form of textual labels, numerical ratings, or categorical tags that indicate the presence or intensity of specific emotions. For example, an image of a serene landscape may be labeled with emotions such as “calm,” “peaceful,” or “tranquil,” while a video clip of a lively festival may be annotated with emotions like “excitement,” “joy,” or “energetic.”

The training dataset 310 can undergo a preprocessing step 316 to prepare the data for training the emotion-visual generative model 130. The preprocessing step 316 can involve various techniques to clean, normalize, and/or transform the raw multimedia data into a suitable format for model training. This may include resizing images to a consistent resolution, cropping or padding videos to a fixed length, and converting data into standardized formats such as JPEG or MP4. Additionally, the preprocessing step 316 may involve data augmentation techniques, such as random rotations, flips, or color adjustments, to increase the diversity and robustness of the training dataset 310. The preprocessing step 316 can ensure that the data is consistent, compatible, and optimized for effective model training.

The preprocessed dataset can then be fed into the training process 320, where the emotion-visual generative model 130 learns to capture the relationships between visual elements and emotional expressions. The training process 320 can typically involve a deep learning architecture, such as a generative adversarial network (GAN) or a variational autoencoder (VAE), which consists of an encoder 324 and a decoder 326. The encoder 324 can learn to map the input visual data into a compact latent space representation, capturing salient features and emotional attributes of the data. As the training data passes through the encoder 324, it can be transformed into a lower-dimensional representation that encodes the essential characteristics and emotional qualities of the visual content. The encoder 324 can extract hierarchical features from the input data, learning to capture both low-level visual patterns and high-level semantic information associated with emotions.

The decoder 326, on the other hand, can learn to reconstruct the visual data from the latent space representation generated by the encoder 324. The decoder 326 can take the compressed representation from the latent space and generate new designs that exhibit the desired emotional qualities. During the training process 320, the decoder 326 can learn to map the latent space representation back to the original visual domain, creating synthetic designs that resemble the training data while incorporating the specified emotional attributes. Through an iterative training process 320, the emotion-visual generative model 130 can learn to disentangle the emotional aspects from the visual elements, allowing it to generate novel designs that combine the specified emotions with the visual characteristics of the input design elements. The training process 320 can involve various loss functions and optimization techniques, such as adversarial losses, perceptual losses, or emotional similarity metrics, to guide the model towards generating emotionally expressive and visually coherent designs.

The training process 320 can result in a trained model 328, which encapsulates the learned mappings between visual elements and emotional attributes. The trained model 328 can take user inputs, such as design elements and emotional specifications, and generate corresponding designs that embody the desired emotions. The model's architecture and learned parameters can enable it to synthesize designs by sampling from the latent space and decoding the representations into visual outputs. The trained model 328 can generate static images, animated sequences, or interactive visualizations, depending on the specific requirements of the emotion-based design generation system 100.

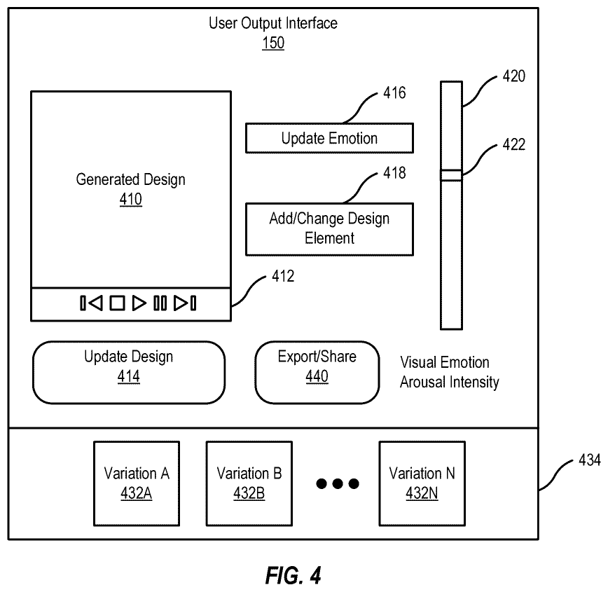

In accordance with aspects of the present disclosure, FIG. 4 illustrates an example of the user output interface 150 of the emotion-based design generation system 100. The user output interface 150 can provide a dynamic and interactive platform for users to view, explore, and manipulate the generated designs that embody the specified emotions and design elements. The user output interface 150 can prominently display the generated design 410, which can be the visual or multimedia output produced by the emotion-visual generative model 130 based on the user's inputs. The generated design 410 can take various forms, such as a static image, an animated sequence, or an interactive visualization, depending on the capabilities of the generative model and the user's preferences. For example, if the user selected “leaf” as the design element and “excitement” as the desired emotion, the generated design 410 might depict a vibrant and dynamic leaf motif with swirling patterns, bold colors, and energetic movements that evoke a sense of excitement.

The generated design 410 can be presented in a visually appealing and immersive manner, allowing the user to fully appreciate the emotional qualities and aesthetic details of the design. The user output interface 150 may provide zoom and pan functionalities, enabling the user to explore different aspects of the design at various levels of detail. The interface may also include a playback control 412 for animated or interactive designs, allowing the user to start, pause, or navigate through the temporal progression of the design. This interactive feature can enhance the user's engagement with the generated design and allow them to experience the emotional narrative or dynamic aspects of the design.

Alongside the generated design 410, the user output interface 150 can include an update design button 414. The update design button 414 can provide users with the ability to modify or refine the generated design based on their preferences or feedback. When the user clicks or taps the update design button 414, the emotion-based design generation system 100 can re-generate the design, incorporating any changes or adjustments made by the user. This iterative process allows users to fine-tune the generated design until it aligns with their creative vision and emotional goals. In some aspects, the user output interface 150 can include an update emotion field 416. The update emotion field 416 can allow users to modify the emotional attributes associated with the generated design. Users can enter new emotions or adjust the intensity of existing emotions to explore different emotional variations of the design. For example, if the user initially specified “excitement” as the desired emotion but later wants to explore a more subdued or contemplative mood, they can update the emotion field 416 with emotions like “serenity” or “introspection.” The emotion-based design generation system 100 (FIG. 1) can then re-generate the design, incorporating the updated emotional attributes and producing a new visual representation that reflects the modified emotional intent. In some examples, section 434 may include alternative design variations 432A, 432B, and 432N, in which a user may view, select, and/or interact with.

The user output interface 150 can also include an add/change design element field 418. The add/change design element field 418 can enable users to introduce new design elements or modify existing ones in the generated design. Users can input additional objects, shapes, or visual components that they want to incorporate into the design. For example, if the user wants to add a specific geometric shape or a particular texture to the generated leaf design, they can use the add/change design element field 418 to specify those elements. The emotion-based design generation system 100 (FIG. 1) can then integrate the new design elements into the generated design, creating a more customized and personalized visual representation.

In some examples, the user output interface 150 can include a visual emotion arousal level element 420. The visual emotion arousal level element 420 can provide users with a way to adjust the intensity or strength of the emotions conveyed in the generated design. It can be represented as a slider, a set of input fields, or any other interactive control that allows users to modulate the emotional arousal level. Users can manipulate the visual emotion arousal level element 420 to make the generated design more subtle or more pronounced in terms of its emotional expression. The visual emotion arousal level slider 422 can be a specific implementation of the visual emotion arousal level element 420. The visual emotion arousal level slider 422 can provide an intuitive and user-friendly way for users to adjust the emotional intensity by dragging a slider handle or clicking on a specific point along the slider. The bottom end of the slider may represent a low arousal level, while the top end may represent a high arousal level. Users can move the slider to the desired position to indicate the desired emotional intensity in the generated design. The emotion-based design generation system 100 (FIG. 1) can then adapt the generated design accordingly, modifying visual elements, colors, or motion patterns to reflect the specified arousal level.

In some aspects, the user output interface 150 can include an export/share button 440. The export/share button 440 can allow users to save, export, or share the generated designs for further use or collaboration. When the user clicks or taps the export/share button 440, the emotion-based design generation system 100 (FIG. 1) can provide options to save the generated design in various file formats, such as PNG, JPEG, or SVG for static images, or MP4, GIF, or HTML for animated or interactive designs. Users can choose the desired file format and resolution based on their intended use case, such as incorporating the design into a website, presentation, or creative project.

The export/share button 440 can also enable users to directly share the generated design on social media platforms, design communities, or collaborative workspaces. This functionality can allow users to showcase their emotion-driven designs, gather feedback from others, and engage in creative discussions or collaborations. The export/share button 440 can streamline the process of integrating the generated designs into the user's workflow and facilitate the dissemination of their creative work.

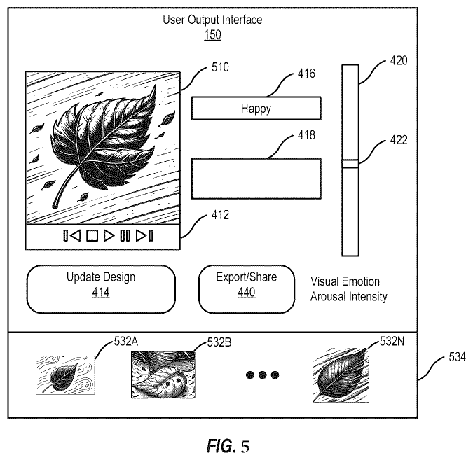

In accordance with aspects of the present disclosure, FIG. 5 illustrates an example application of the emotion-based design generation system 100 in the context of product design. In some aspects, FIG. 5 demonstrates how a product designer can leverage the system to create emotionally resonant and inspiring designs for various products or objects.

The product design process begins with the designer interacting with the user input interface 110 (FIG. 2) of the emotion-based design generation system 100 (FIG. 1). The designer starts by specifying the product or object they wish to design, such as a teapot, a chair, or a car, in the design element 212 (FIG. 2). This input serves as the foundation for the generated design and helps contextualize the emotional expression within the specific product domain.

Next, the designer selects the desired emotion they want to embed into the product design using the emotional input section 214 (FIG. 2). For example, if the designer wants to create a teapot that evokes a sense of tranquility and relaxation, they may select emotions such as “calm,” “serene,” or “peaceful.” The designer can also adjust the emotional intensity using the visual emotion arousal level slider 218 (FIG. 2) to modulate the strength of the selected emotions in the generated design.

Once the designer has provided the necessary inputs, they click the “Generate Design” button 224 (FIG. 2) to initiate the design generation process. The emotion-based design generation system 100 (FIG. 1) processes the inputs, leverages the trained emotion-visual generative model 130 (FIG. 1), and generates a visually inspiring design 510 that embodies the specified emotions within the context of the selected product or object.

The generated design 510 is displayed on the user output interface 150, allowing the designer to view and interact with the emotionally expressive design. The design 510 may take the form of a static image, a 3D rendering, or an animated representation of the product, depending on the designer's preferences and the capabilities of the generative model. For instance, in the case of a sad, wind-blown leaf, the generated design 510 may showcase a leaf being blown in the wind, with soft, curved lines, a sad color palette, and a form that evokes a sense of sadness.

The designer can explore and refine the generated design 510 using the interactive features provided by the user output interface 150. They can adjust the emotional intensity using the visual emotion arousal level slider 422, experiment with different design variations 532A, 532B, 532N in a variation section 534, and fine-tune the visual elements to align with their creative vision. The iterative nature of the emotion-based design generation system 100 allows the designer to generate multiple design alternatives and explore various emotional expressions within the product design space.

Once the designer is satisfied with the generated design 510, they can use it as a visual reference, inspiration, or starting point for their subsequent design process. The designer can incorporate the emotional qualities and aesthetic elements of the generated design into their own design workflow, using traditional design tools and techniques. For example, the designer may import the generated leaf design into a 3D modeling software, refine the shape, add functional elements, and create detailed product specifications based on the emotionally inspiring design.

Throughout the product design process, the emotion-based design generation system 100 (FIG. 1) serves as a valuable tool for designers, providing them with emotionally resonant and visually inspiring designs that can guide and enhance their creative process. By leveraging the system's ability to generate designs based on specific emotions and product contexts, designers can explore a wide range of emotional expressions and create products that resonate with users on a deeper, more meaningful level.

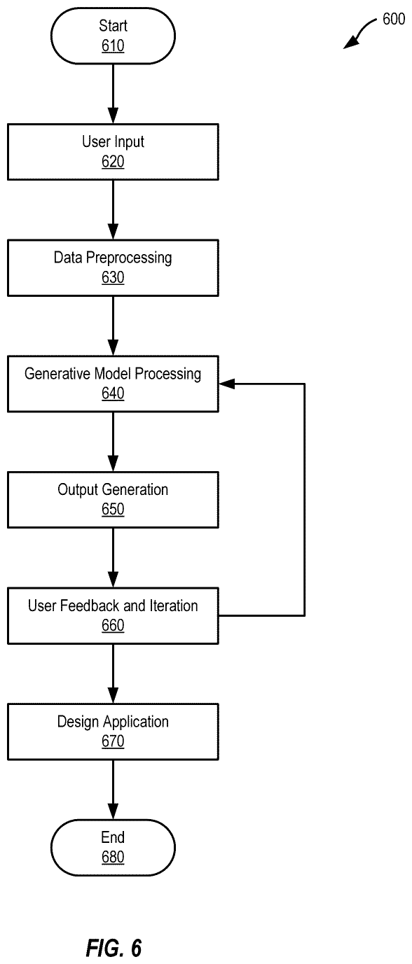

In accordance with aspects of the present disclosure, FIG. 6 illustrates a flowchart depicting a process 600 of using the emotion-based design generation system 100 of FIG. 1. The flowchart outlines a user's interaction with the emotion-based design generation system 100 of FIG. 1, from providing initial inputs to generating and utilizing the emotionally resonant designs. The process 600 begins at the “Start” block 610, indicating the entry point of the user's interaction with the emotion-based design generation system 100. From there, the user can proceed to the “User Input” block 620, where a user can provide the necessary information to guide the design generation process.

In the “User Input” block 620, the user can specify various parameters and preferences to influence the generated design. This may include selecting the design element or product they wish to create, such as a teapot, a chair, or a logo. The user can also choose the desired emotion or emotions they want to convey through the design, such as happiness, calmness, or excitement. Additionally, the user has the option to adjust the emotional intensity using a slider or input field, allowing them to modulate the strength of the selected emotions in the generated design. The user input stage provides the foundation for the subsequent steps in the design generation process.

After specifying various parameters and preferences to influence the generated design, the process 600 moves to the “Data Preprocessing” block 630. In this step, the user's inputs can be preprocessed and formatted to be compatible with the emotion-visual generative model 130. The design element input can be converted into a suitable representation, such as a text prompt or a set of descriptive features. The emotional inputs can be encoded into a numerical or categorical format that can be understood by the generative model. If the user has specified their current emotional state using sensors or input devices, that information can also be processed and integrated with the other inputs. The data preprocessing step ensures that the user's inputs are transformed into a consistent and usable format for the subsequent steps.

Once the data preprocessing is complete or otherwise nearing completion, the user can proceed to the “Generative Model Processing” block 640. In this step, the preprocessed user inputs can be fed into the emotion-visual generative model 130. The emotion-visual generative model 130 takes the design element, emotional inputs, and any additional user preferences and generates a unique design that combines the specified visual elements with the desired emotional attributes. The emotional inputs can be transformed into emotion encoding parameters, which are numerical or categorical representations that capture the essential characteristics and attributes of the desired emotions. These emotion encoding parameters enable the generative model to understand and incorporate the specified emotions into the generated design. The generative model leverages its trained knowledge of the relationships between visual elements and emotions to create a design that effectively conveys the intended emotional expression. The emotion-visual generative model 130 can leverage its trained knowledge of the relationships between visual elements and emotions to create a design that effectively conveys the intended emotional expression. The model can encode the user's inputs into a latent space representation, capturing the essential characteristics and emotional qualities of the desired design. By sampling from this latent space and decoding the representations, the generative model can synthesize novel and diverse designs that align with the user's specifications. The generated design can be in various formats, such as a static image, an animation, or an interactive visualization, depending on the capabilities of the generative model and the user's preferences.

The generated design is then passed to the “Output Generation” block 650. In this step, the generated design can be post-processed and formatted for display to the user. Any necessary refinements, such as resizing, cropping, or color adjustments, can be applied to ensure that the design is visually appealing and aligned with the user's expectations. If the user has specified any additional preferences or constraints, such as a specific color palette or style, those can be incorporated into the final output. The output generation block 650 may also involve creating multiple variations of the generated design, allowing the user to explore different visual interpretations or styles that still maintain the desired emotional expression.

After the output generation is complete, the process 600 moves to the “User Feedback and Iteration” block 660. In this step, the generated design is presented to the user through the user output interface 150. The user can view the design, interact with it, and provide feedback or make adjustments. The user output interface 150 can offer various interactive features, such as emotional intensity sliders, design variation selectors, and pan/zoom controls, enabling the user to refine and customize the generated design according to their preferences.

If the user is not satisfied with the initial output, they can iterate by adjusting the emotional inputs, modifying the design elements, or exploring different design variations. The user can repeat the feedback and iteration process until they achieve a design that aligns with their creative vision and emotional goals. This iterative loop allows for a collaborative and interactive design process, where the user and the emotion-based design generation system 100 (FIG. 1) work together to create emotionally resonant designs that meet the user's expectations.

Once the user is satisfied with the generated design, they proceed to the “Design Application” block 670. In this step, the user can utilize the emotionally resonant design in their intended application or project. For example, if the user is a product designer, they can incorporate the generated design into their product development process, using it as a visual reference, inspiration, or starting point for further refinement and detailed design work. If the user is a graphic designer, they can integrate the generated design into their branding or marketing materials, leveraging the emotional qualities to create impactful and engaging visuals. The design application 670 step allows the user to incorporate the emotion-based generated designs into their creative workflows and projects. The generated designs can serve as a valuable resource for ideation, exploration, and communication, enabling designers to convey specific emotions and create designs that resonate with their target audience. Finally, the process 600 reaches the “End” block 680, signifying the completion of the user's interaction with the emotion-based design generation system 100.

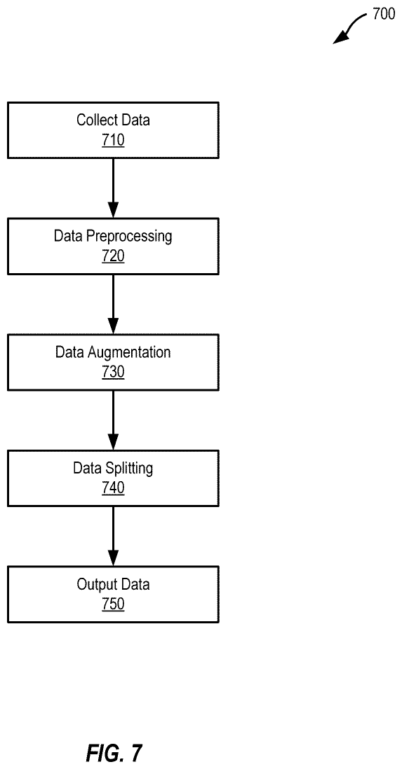

In accordance with aspects of the present disclosure, FIG. 7 illustrates a training data pipeline 700 for the emotion-visual generative model used in the emotion-based design generation system 100. The training data pipeline 700 encompasses the processes of data collection, preprocessing, augmentation, and splitting, which collectively contribute to the creation of a specialized dataset for training the model to generate emotionally resonant designs. The training data pipeline 700 begins with the “Collect Data” block 710. This step involves gathering a diverse range of multimedia content from various sources, such as art repositories, design portfolios, photography databases, and user-generated content platforms. The collected data can include images, videos, and other visual representations that span different domains, styles, and emotional attributes. The data collection process aims to curate a comprehensive and balanced dataset that captures a wide spectrum of visual and emotional variations. In some aspects, the data collection block 710 may involve manual curation by domain experts who carefully select and annotate the multimedia content based on its emotional qualities and relevance to the design generation task. Additionally, automated data scraping techniques can be employed to gather a large volume of data from online sources, leveraging metadata and user-generated tags to identify emotionally relevant content. The collected data serves as the raw material for the subsequent stages of the training data pipeline.

After data collection, the training data pipeline 700 proceeds to the “Data Preprocessing” block 720. In this step, the collected multimedia content undergoes various preprocessing techniques to ensure data quality, consistency, and compatibility with the emotion-visual generative model. The preprocessing step 720 can involve tasks such as data cleaning, normalization, and formatting. Data cleaning can include removing duplicates, filtering out irrelevant or low-quality data, and handling missing or corrupted files. Normalization techniques can be applied to standardize the data format, resolution, and color space across the dataset. This can help to ensure that the training data is consistent and comparable, facilitating effective model training. Additionally, the preprocessing step 720 may involve resizing images to a uniform resolution, cropping or padding videos to a fixed length, and converting the data into a suitable format for input to the generative model, such as tensors or numerical representations.

In some examples, the training data pipeline 700 may include an optional “Data Augmentation” block 730. Data augmentation techniques can be applied to the preprocessed data to expand the dataset and introduce additional variations, thereby improving the robustness and generalization capabilities of the emotion-visual generative model. Data augmentation can involve techniques such as random rotations, flips, translations, scaling, and color adjustments. By applying these transformations to the preprocessed data, new synthetic samples can be generated, increasing the diversity of the training dataset. For example, an image of a smiling face can be rotated, flipped, or adjusted in brightness to create multiple variations while preserving the underlying emotional expression. Data augmentation helps the generative model learn to be invariant to various transformations and improves its ability to generate emotionally consistent designs across different variations.

The augmented dataset then undergoes a “Data Splitting” process in block 740. In this step, the dataset is divided into separate subsets for training, validation, and testing purposes. The training subset can be used to train the emotion-visual generative model 130 (FIG. 1), allowing it to learn the mapping between visual elements and emotional attributes. The validation subset can be used to monitor the model's performance during training, enabling hyperparameter tuning and model selection. The testing subset can be held out and used to evaluate the trained model's performance on unseen data, assessing its ability to generate emotionally resonant designs.

The data splitting process 740 can follow various strategies, such as random splitting or stratified sampling, to ensure that each subset is representative of the overall data distribution. The split ratios can be adjusted based on the size of the dataset and the specific requirements of the training process. For example, a common split ratio is 80% for training, 10% for validation, and 10% for testing. The data splitting step helps to ensure that the emotion-visual generative model 130 (FIG. 1) is trained on a diverse set of examples while providing separate subsets for performance evaluation and model selection.

Finally, the training data pipeline 700 culminates in the “Output Training Dataset” block 750. This block represents a final output of the pipeline, which is a specialized training dataset optimized for training the emotion-visual generative model. The output training dataset can include the preprocessed and augmented multimedia content, along with the corresponding emotional labels or annotations. The output training dataset 750 can be structured in a format that is compatible with the input requirements of the emotion-visual generative model. This may involve organizing the data into batches, creating data generators, or storing the data in a suitable file format, such as HDF5 or TFRecords. The output training dataset 750 serves as the input to the model training process, where the emotion-visual generative model 130 (FIG. 3) learns to capture the complex relationships between visual elements and emotional attributes.

In some aspects, the output training dataset 750 may also include additional metadata or annotations that can aid in the training process. For example, the output training dataset 750 may include information about the data source, emotional intensity levels, or specific visual attributes that are relevant to the design generation task. This metadata can be leveraged during training to provide additional guidance or constraints to the generative model, improving its ability to generate emotionally coherent and visually appealing designs.

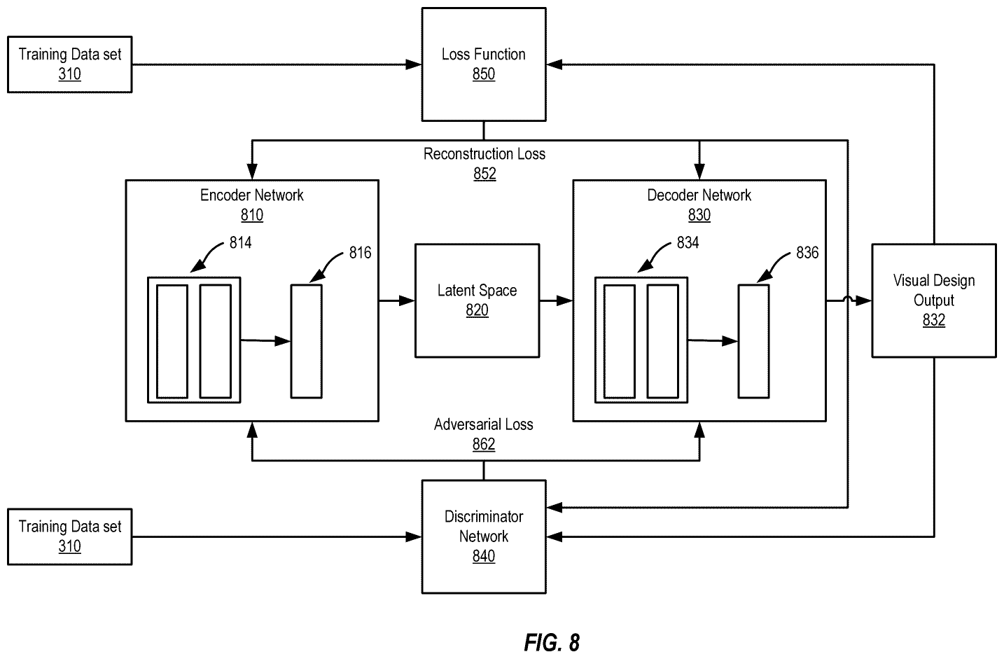

In accordance with aspects of the present disclosure, FIG. 8 illustrates components and data flow within an example emotion-visual generative model architecture. The architecture can include an encoder network 810, a latent space 820, a decoder network 830, and a discriminator network 840, which work together to enable the generation of emotionally resonant designs. The encoder network 810 takes as input, the emotionally annotated visual data from a training data set 310, which can include design elements and their corresponding emotional attributes. The visual data can be in the form of images, videos, or other visual representations, and the emotional attributes can be labels and/or descriptors that indicate the desired emotions to be evoked.

The encoder network 810 can be composed of a series of convolutional layers 814 followed by fully connected layers 816. The convolutional layers 814 can apply learned filters to the input data, extracting hierarchical features that capture both low-level details and high-level semantic information. As data passes through successive convolutional layers 814, features become increasingly abstract and representative of the emotional qualities present in the input. The fully connected layers 816 can then integrate the extracted features from different spatial locations and map them into a compact latent space representation 820.

The latent space 820 can be a compressed and abstract encoding of the emotionally annotated visual data from a training data set 310, capturing emotional attributes and visual characteristics. The latent space 820 serves as a lower-dimensional representation of the emotionally annotated visual data from a training data set 310, containing information for generating emotionally resonant designs. The dimensionality of the latent space 820 can be adjusted based on the complexity of the design space and the desired level of abstraction. The latent space 820 acts as a bridge between the encoder network 810 and the decoder network 830, enabling the generation of emotionally expressive designs.

In some aspects, the decoder network 830 takes the latent space 820 as input and generates the corresponding visual design output 832. The decoder network 830 can include of a series of transposed convolutional layers 834 followed by fully connected layers 836. The transposed convolutional layers 834 can perform the opposite operation of the convolutional layers 814 in the encoder network 810, gradually upsampling the latent space 820 and increasing its spatial resolution. The transposed convolutional layers 834 can apply learned filters to the latent representation 820, reconstructing visual elements and incorporating emotional attributes encoded in the latent space.

In some aspects, as the data passes through the decoder network 830, the emotional attributes and visual characteristics are combined and transformed into a coherent and emotionally expressive design. The fully connected layers 836 can integrate the information from the latent space 820 and guide the generation process towards the desired emotional qualities. The output of the decoder network 830 can be the generated visual design output 832, which embodies the specified emotional attributes in a nuanced and visually appealing manner.

The discriminator network 840 can be used in the training process of an emotion-visual generative model. It can be used to improve the quality and realism of the generated designs through an adversarial training approach. The discriminator network 840 can take as input both the real visual data from the training dataset 310 and the generated visual design output 832 from the decoder network 830. In some aspects, the objective of the discriminator network 840 is to distinguish between the real and generated designs, providing feedback to the generator (e.g., encoder-decoder network comprising encoder network 810, latent space 820, and decoder network 830) to improve the quality and emotional coherence of the generated designs.

During training, the discriminator network 840 can learn to classify the input designs as real or generated. The discriminator network 840 can be trained simultaneously with the generator network (e.g., encoder-decoder network comprising encoder network 810, latent space 820, and decoder network 830) in an adversarial manner. The generator network (e.g., encoder-decoder network comprising encoder network 810, latent space 820, and decoder network 830) aims to generate designs that fool the discriminator network 840. The discriminator network 840 tries to accurately distinguish between real and generated designs. This adversarial training process encourages the generator (e.g., encoder-decoder network comprising encoder network 810, latent space 820, and decoder network 830) to produce designs that are indistinguishable from real designs, ensuring that the generated designs are realistic and emotionally resonant.

In some aspects, the training process of the emotion-visual generative model involves the optimization of a loss function 850. The loss function 850 can quantify the difference between the generated designs and the desired emotional attributes. The loss function 850 can include multiple components, such as a reconstruction loss 852. The reconstruction loss 852 measures the dissimilarity between the generated designs (e.g., 832) and the corresponding input designs (e.g., from the training dataset 310). The reconstruction loss 852 helps the generated designs preserve the visual characteristics and emotional attributes of the input data. The reconstruction loss 852 can be calculated using metrics such as mean squared error or perceptual loss, which compare the generated designs with the ground truth designs in terms of pixel-wise similarity or higher-level feature similarity.

In some aspects, adversarial loss 862 can be derived from the feedback provided by the discriminator network 840. The adversarial loss 862 can quantify how well the generated designs (e.g., visual design output 832) fool the discriminator network 840 into classifying them as real designs. The adversarial loss 862 encourages the generator network (e.g., encoder-decoder network comprising encoder network 810, latent space 820, and decoder network 830) to produce designs that are indistinguishable from real designs, thereby improving the realism and emotional coherence of the generated designs.

During the training process, the encoder network 810, decoder network 830, and discriminator network 840 can be iteratively updated based on the gradients calculated from the loss function 850 (e.g., reconstruction loss 852) and the adversarial loss 862. A backpropagation algorithm can be used to propagate the gradients through the networks, allowing the model parameters to be adjusted in a way that minimizes the reconstruction loss and maximizes the adversarial loss. This iterative optimization process enables the emotion-visual generative model to learn the complex mappings between visual elements and emotional attributes, ultimately enabling the generation of emotionally resonant designs.

The emotion-visual generative model architecture, as depicted in FIG. 8, enables the generation of designs that evoke emotions in a nuanced and visually compelling manner. By leveraging the power of deep learning and adversarial training, the model learns to capture the intricate relationships between visual elements and emotional attributes. The encoder network 810 maps the input data into a compact latent space representation 820, capturing the essential emotional and visual characteristics. The decoder network 830 then takes the latent representation and generates the corresponding visual design output 832, incorporating the emotional qualities encoded in the latent space. The discriminator network 840 enhances the realism and emotional coherence of the generated designs through adversarial training. By optimizing the loss function 850, which includes the reconstruction loss 852 and adversarial loss 862, the emotion-visual generative model learns to generate designs that effectively convey desired emotions and resonate with users on a deep, meaningful level.

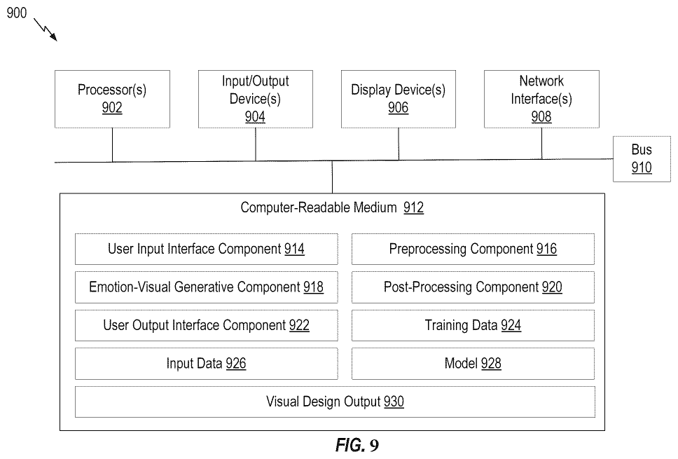

FIG. 9 depicts an example processing system 900 configured to perform various aspects described herein, including, for example, process 600 and/or pipeline process 700 as described above with respect to FIG. 6 and FIG. 7.

Processing system 900 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 900 includes one or more processors 902, one or more input/output devices 904, one or more display devices 906, one or more network interfaces 908 through which processing system 900 is connected to one or more networks (e.g., a local network, an intranet, the Internet, or any other group of processing systems communicatively connected to each other), and computer-readable medium 912. In the depicted example, the aforementioned components are coupled by a bus 910, which may generally be configured for data exchange amongst the components. Bus 910 may be representative of multiple buses, while only one is depicted for simplicity.

Processor(s) 902 are generally configured to retrieve and execute instructions stored in one or more memories, including local memories like computer-readable medium 912, as well as remote memories and data stores. Similarly, processor(s) 902 are configured to store application data residing in local memories like the computer-readable medium 912, as well as remote memories and data stores. More generally, bus 910 is configured to transmit programming instructions and application data among the processor(s) 902, display device(s) 906, network interface(s) 908, and/or computer-readable medium 912. In certain embodiments, processor(s) 902 are representative of a one or more central processing units (CPUs), graphics processing unit (GPUs), tensor processing unit (TPUs), accelerators, and other processing devices.

Input/output device(s) 904 may include any device, mechanism, system, interactive display, and/or various other hardware and software components for communicating information between processing system 900 and a user of processing system 900. For example, input/output device(s) 904 may include input hardware, such as a keyboard, touch screen, button, microphone, speaker, and/or other device for receiving inputs from the user and sending outputs to the user.

Display device(s) 906 may generally include any sort of device configured to display data, information, graphics, user interface elements, and the like to a user. For example, display device(s) 906 may include internal and external displays such as an internal display of a tablet computer or an external display for a server computer or a projector. Display device(s) 906 may further include displays for devices, such as augmented, virtual, and/or extended reality devices. In various embodiments, display device(s) 906 may be configured to display a graphical user interface.

Network interface(s) 908 provide processing system 900 with access to external networks and thereby to external processing systems. Network interface(s) 908 can generally be any hardware and/or software capable of transmitting and/or receiving data via a wired or wireless network connection. Accordingly, network interface(s) 908 can include a communication transceiver for sending and/or receiving any wired and/or wireless communication.

Computer-readable medium 912 may be a volatile memory, such as a random access memory (RAM), or a nonvolatile memory, such as nonvolatile random access memory (NVRAM), or the like. In this example, computer-readable medium 912 includes a user input interface component 914, a preprocessing component 916, an emotion-visual generative component 918, a post-processing component 920, a user output interface component 922, training data 924, input data 926, model 928, and visual design output 930.

In certain embodiments, component 914 is configured to provide a user-friendly interface for users to input design preferences and emotional intentions in accordance with aspects described herein. Component 916 is configured to preprocess and format user inputs for utilization by subsequent components in accordance with aspects described herein. Component 918 is configured to generate emotionally resonant designs using the trained emotion-visual generative model in accordance with aspects described herein. Component 920 is configured to refine and adapt the generated designs based on user preferences and constraints in accordance with aspects described herein. Component 922 is configured to present the generated designs to users for viewing, interaction, and feedback in accordance with aspects described herein. Component 924 is configured to store training data in accordance with aspects described herein. Component 926 is configured to receive and/or store input data in accordance with aspects described herein. Component 928 is configured to store a model in accordance with aspects described herein. Component 930 is configured to store and/or provide the visual design output in accordance with aspects described herein.

Note that FIG. 9 is just one example of a processing system consistent with aspects described herein, and other processing systems having additional, alternative, or fewer components are possible consistent with this disclosure.

Building upon the aspects described above, the emotion-based design generation system enables designers to create emotionally resonant designs by leveraging machine learning and generative models. The system allows users to input design elements, emotions, and intensities through an intuitive user interface. The emotion-visual generative model, trained on a diverse dataset of emotionally annotated multimedia content, generates designs that effectively convey the desired emotions. The generated designs can be refined and customized through interactive controls, providing flexibility and creative control to the designers.

It should now be understood that embodiments disclosed herein are directed to systems and methods for generating emotionally resonant designs using machine learning techniques and generative models. The emotion-based design generation system described herein provides a technical solution to the problem of creating emotionally evocative designs in a manual, time-consuming, and subjective manner. By leveraging deep learning and adversarial training, the system enables designers to generate designs that effectively convey desired emotions based on user inputs and preferences. This improves upon existing design tools that rely heavily on the designer's intuition and expertise, lacking systematic and data-driven approaches to capturing and integrating emotional attributes into the design process.

The integration of the emotion-visual generative model with user input interfaces and output interfaces adds additional functionality to conventional design workflows. The ability to input design elements, emotions, and intensities through a user-friendly interface provides a flexible and intuitive means for designers to express their creative intent. The generative model, trained on a diverse dataset of emotionally annotated multimedia content, learns the intricate relationships between visual elements and emotional attributes, enabling the generation of designs that effectively evoke the desired emotions. This provides a technical improvement over existing design tools that lack the capability to capture and incorporate emotional aspects in a data-driven and automated manner.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for generating emotionally resonant visual content, the method comprising:
receiving multimodal data comprising at least one design element and emotion input data associated with one or more target emotional states;
determining emotion encoding parameters corresponding to the one or more target emotional states;
generating, using a machine learning model trained on training data encoding correlations between emotion encoding parameters and visual properties, synthetic visual content reflecting the at least one design element and the one or more target emotional states; and
displaying, in a user interface, the synthetic visual content reflecting the target emotional states, the user interface configured to receive one or more controls to modify at least one of the emotion input data or the target emotional states to modify the displayed synthetic visual content.

2. The method of claim 1, wherein the multimodal data further comprises text data, and wherein the emotion input data is determined based on the text data.

3. The method of claim 1, wherein the multimodal data further comprises audio data, and wherein the emotion input data is determined based on the audio data.

4. The method of claim 1, wherein the multimodal data further comprises physiological data, and wherein the emotion input data is determined based on the physiological data.

5. The method of claim 1, wherein the emotion encoding parameters comprise numerical values representing emotional attributes along one or more dimensions.

6. The method of claim 1, wherein the machine learning model is a generative adversarial network (GAN) comprising a generator network and a discriminator network.

7. The method of claim 6, wherein the generator network comprises an encoder network and a decoder network, and wherein the encoder network is configured to map the multimodal data into a latent space representation.

8. The method of claim 7, wherein the decoder network is configured to generate the synthetic visual content based on the latent space representation and the emotion encoding parameters.

9. The method of claim 1, wherein the training data comprises a dataset of emotionally annotated multimedia content.

10. The method of claim 1, further comprising:
receiving, via the user interface, user feedback on the displayed synthetic visual content;
updating the emotion input data or the target emotional states based on the user feedback; and
generating updated synthetic visual content based on the updated emotion input data or target emotional states.

11. An apparatus configured to generate emotionally resonant visual content, the apparatus comprising:
one or more memories configured to store information corresponding to multimodal data comprising at least one design element and emotion input data associated with one or more target emotional states; and
one or more processors, coupled to the one or more memories, configured to:
determine emotion encoding parameters corresponding to the one or more target emotional states;
generate synthetic visual content reflecting the at least one design element and the one or more target emotional states; and
display, in a user interface, the synthetic visual content reflecting the target emotional states, the user interface configured to receive one or more controls to modify at least one of the emotion input data or the target emotional states to modify the displayed synthetic visual content.

12. The apparatus of claim 11, wherein the multimodal data further comprises text data, and wherein the emotion input data is determined based on the text data.

13. The apparatus of claim 11, wherein the multimodal data further comprises audio data, and wherein the emotion input data is determined based on the audio data.

14. The apparatus of claim 11, wherein the multimodal data further comprises physiological data, and wherein the emotion input data is determined based on the physiological data.

15. The apparatus of claim 11, wherein the emotion encoding parameters comprise numerical values representing emotional attributes along one or more dimensions.

16. The apparatus of claim 11, wherein to generate synthetic visual content reflecting the at least one design element and the one or more target emotional states comprises to:
generate, using a machine learning model trained on training data encoding correlations between emotion encoding parameters and visual properties, the synthetic visual content reflecting the at least one design element and the one or more target emotional states, wherein the machine learning model is a generative adversarial network (GAN) comprising a generator network and a discriminator network.

17. The apparatus of claim 16, wherein the generator network comprises an encoder network and a decoder network, and wherein the encoder network is configured to map the multimodal data into a latent space representation.

18. The apparatus of claim 17, wherein the decoder network is configured to generate the synthetic visual content based on the latent space representation and the emotion encoding parameters.

19. The apparatus of claim 16, wherein the training data comprises a dataset of emotionally annotated multimedia content.

20. The apparatus of claim 11, wherein the one or more processors are configured to:
receive, via the user interface, user feedback on the displayed synthetic visual content;
update the emotion input data or the target emotional states based on the user feedback; and
generate updated synthetic visual content based on the updated emotion input data or target emotional states.
